(19) United States
(12) Patent Application Publication
(10) Pub. No.: US 2006/0085173 A1
(43) Pub. Date: Apr. 20, 2006

(54) Science and engineering simulator using numerical analysis of simultaneous linear equations

(75) Inventors: Ken Takei, Hitachi (JP); Tomoyuki Ogawa, Hitachi (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 11/253,809

(22) Filed: Oct. 20, 2005

(30) Foreign Application Priority Data
Oct. 20, 2004 (JP) 2004-305874

(51) Int. Cl. G06F 17/10

(52) U.S. Cl. 703/2

(57) ABSTRACT

A science and engineering simulator using numerical analysis of simultaneous linear equations is provided with a first storage means for storing a coefficient matrix Z of rank-N simultaneous linear equations; a second storage means for storing a rank-N constant vector V; a third storage means for storing a rank-n (n<N) updated coefficient matrix z; a fourth storage means for storing a rank-n updated constant vector v; a first temporary storage area for storing a rank-n unknown vector I; a second temporary storage area for storing a rank-n candidate matrix C; a third temporary storage area for storing a rank-n degenerate vector E; and an arithmetic unit for executing an algorithm for searching I(ept) determined to converge to a particular value opt with predetermined tolerance deviation tol, where the I(ept) is a coefficient of an unknown vector I corresponding to a particular column ept of the coefficient matrix Z.

The present application is based on Japanese patent application No. 2004-305874, the entire contents of which are incorporated herein by reference.

### BACKGROUND OF THE INVENTION

1. Field of the Invention

The present invention relates to an algorithm for reducing calculation time in numerically analyzing optimization or search problems using simultaneous linear equations, and particularly, to software for science and engineering simulators that are tools for computer simulation of various phenomena in science and engineering.

2. Description of the Related Art

Many various phenomena in science and engineering cannot be verified experimentally, or verification may be difficult due to constraints of time and cost. In that case, it is common practice that, using valid physical control equations, physical actual conditions that cause various phenomena to be verified are made discrete, and formulated in a final form of multidimensional simultaneous linear equations, and that computers are used to numerically solve the same simultaneous equations with a suitable algorithm, and that its solutions are used to estimate the various phenomena to be verified. Also, tools for estimating the above various phenomena with computers are called science and engineering simulators, whose actual conditions are general-purpose or single-purpose computer hardware and software programs that describe the same algorithm with a suitable computer language.

One of the main factors that determine the above-mentioned calculation time in science and engine ring is calculation time repeated using simultaneous linear equations. Generally, coefficient matrices of simultaneous linear equations correspond one-to-one with a kind of description form of physical characteristics to be analyzed, so that optimization or search problems with physical quantities for formulated with simultaneous linear equations require solving repeatedly plural simultaneous linear equations of coefficient matrices having different components, which results in a large amount of consumption of calculation time. For this reason, calculation time of simultaneous linear equations becomes the main factor of limiting calculation speed in science and engineering in the case of the large number of elements (segments) made discrete after physical actual conditions that cause various phenomena to be particularly verified are made discrete, in other words, in the case of a large ratio of size in which behavior of physical control equations used is allowable as a linear function and size of the same physical actual conditions.

In this case, i.e., in the case of large dimensions of simultaneous linear equations, the important technical problem is how to numerically analyze simultaneous linear equations with high speed. For high speed numerical analysis of simultaneous linear equations, various technique have been proposed from hardware and software aspects. However, since hardware high-speed methods require the development of single-purpose computer hardware, there is the problem of high cost compared to software high-speed methods.

The software high-speed method are classified into OS (operation system) level and program algorithm level high-speed methods. The program algorithm level high-speed methods which are lower in development cost are preferred from the point of view of commercial use of science and engineering simulators. Since the program algorithm level high-speed methods of simultaneous linear equations may use general-purpose computer hardware and general-purpose OS which are huge in development cost, it is possible to provide users with low-cost science and engineering simulators, and with further high-speed simulation by using simultaneously expensive and high-performance computer hardware and OS which are possible to co-exist with high-speed methods by computer hardware and OS levels.

As known hardware high-speed methods, there are the method for ensuring high-speed elimination by splitting a coefficient matrix of simultaneous linear equations, allocating it to a plurality of processors and using parallel processing (Japanese patent application laid-open Nos. 5-20348 and 5-20349), the method for high-speed LU-decomposition by splitting a coefficient matrix of simultaneous linear equations, allocating it to a plurality of processors and using parallel processing (Japanese patent application laid-open No. 7-271760), and the method for high-speed repetition by splitting a coefficient matrix of simultaneous linear equations, allocating it to a plurality of processors and using parallel processing (Japanese patent application laid-open No. 9-212483).

In software high-speed methods, as a program algorithm level high-speed method, there has been proposed a high-speed solving method for simultaneous linear equation by detecting the symmetry of a coefficient matrix of the simultaneous linear equations and applying incomplete Cholesky decomposition only in the case of a symmetrical positive definite matrix (Japanese patent application laid-open No. 6-149858). However, no high-speed solving method in program algorithm level for simultaneous linear equations has been obtained which is effective for all simultaneous linear equations regardless of the format of the coefficient matrix of the simultaneous linear equations to be solved. Accordingly, there has been found no method for efficiently solving optimization or search problems with physical quantities formulated with simultaneous linear equations.

As mentioned already, calculation time of simultaneous linear equations becomes the main factor of limiting calculation speed in science and engineering. However, since hardware high-speed methods require the development of single-purpose computer hardware, there is the problem of high cost compared to software high-speed methods. On the other hand, no high-speed solving of program algorithm level simultaneous linear equations has been obtained which is effective in all simultaneous linear equations.

### SUMMARY OF THE INVENTION

It is an object of the present invention to provide a high-speed numerical analysis algorithm, which is effective for efficiently solving optimization or search problems with physical quantities formulated with simultaneous linear equations using software high-speed methods, in order to obviate the above problems and realize a low-cost high-speed science and engineering simulator.

According to the invention, a science and engineering simulator using numerical analysis of simultaneous linear equations comprises:

a first storage means for storing a coefficient matrix Z of rank-N simultaneous linear equations;

a second storage means for storing a rank-N constant vector V;

a third storage means for storing a rank-n (n<N) updated coefficient matrix z;

a fourth storage means for storing a rank-n updated constant vector v;

a first temporary storage area for storing a rank-n unknown vector I;

a second temporary storage area for storing a rank-n candidate matrix C;

a third temporary storage area for storing a rank-n degenerate vector E; and

an arithmetic unit for executing in algorithm for searching I(ept) determined to converge to opt with predetermined tolerance deviation tol, where the I(ept) is a coefficient of an unknown vector I corresponding to a particular column ept of the coefficient matrix Z, and is caused to converge to the particular value opt in an optimization problem, wherein:

the candidate matrix C is each element of a set of a combination of all matrices obtained by deleting a plurality of single or same rows and columns of the coefficient matrix Z;

the degenerate vector E is a vector in which elements corresponding to the deleted columns of the coefficient matrix Z are eliminated from the constant vector V;

the updated coefficient matrix z is a matrix of elements of the set in which, of solutions of the unknown vector I in simultaneous linear equations constructed by the candidate matrix C and the coefficient matrix Z, the I(ept) is determined to be closest to the opt;

the updated constant vector v is a vector constructed by elements of the constant vector V corresponding to the updated coefficient matrix z; and

same operation is repeated sequentially for z and v.

In the science and engineering simulator of the invention, the following modifications or changes can be made.

(i) A check matrix D is multiplied by the unknown vector I obtained for each step m of numerical analysis, the check matrix D comprising elements corresponding to columns contained and rows not contained in the updated coefficient matrix z obtained at the end of each step m, the elements being those of the original coefficient matrix Z; and

when a value of same elements in elements of an obtained vector U is determined to be close to a value of corresponding elements of the constant vector V, rows and columns of Z corresponding to positions of the co responding elements of V are added to the updated coefficient matrix z in step m to create a new updated coefficient matrix z in step m, and elements of V corresponding to positions of the corresponding elements of V are added to the updated constant vector v in step m to create a new updated constant vector v in step m, followed by step m+1 procedure.

(ii) The science and engineering simulator may further comprise:

a fifth storage means for storing an inverse matrix Y of the coefficient matrix Z; and

a sixth storage means for storing an updated inverse matrix y, wherein:

sequential calculation of y corresponding to z for each step is repeated by rank 1 using y in step m−1 and a row vector of z in step m−1 to be deleted in step m, to derive y in step m; and

calculation of the unknown vector I using the candidate matrix C and the degenerate constant vector E for each step is executed by multiplication of y and a constant vector comprising a subset of the corresponding elements of V.

(iii) The science and engineering simulator may further comprise:

a fifth storage means for storing an inverse matrix Y of the coefficient matrix Z; and

a sixth storage means for storing an updated inverse matrix y, wherein:

sequential calculation of y corresponding to z for each step is repeated by rank 1 using y in step m−1 and row and column vectors of z in step m−1 to be added n step m, to derive y in step m; and

modification calculation involving an increase in ranks of the updated coefficient matrix z and the updated inverse matrix y is executed according to determination by the check matrix D.

(iv) The criterion for determining that I(ept) is closest to the target value opt may be defined by the smallest norm formed, by I(ept) and opt.

(v) The criterion for determining that a value of same elements in elements of the obtained vector U is close to a value of corresponding elements of the constant vector V may be defined by the smallest norm formed by the corresponding elements of U and V.

(vi) The science and engineering simulator may aim to analyze structural mechanical properties of the object of analysis.

(vii) The science and engineering simulator may aim to analyze electrical and electronic-circuit properties of the object of analysis.

(viii) The science and engineering simulator may aim to analyze electromagnetic properties of the object of analysis.

(ix) The science and engineering simulator may aim to analyze fluid-dynamic properties of the object of analysis.

### ADVANTAGES OF THE INVENTION

The present invention can offer a high-speed and high-efficiency numerical analysis.

For example, the science and engineering simulator according to the present invention can be used in analyzing structural mechanical properties, electrical and electronic-circuit properties, electromagnetic properties, fluid-dynamic properties of an analyzed object.

The reasons why the above effects can be obtained are as follows;

By virtue of the present invention in the numerical analysis of search or optimization of physical actual conditions of various phenomena using science and engineering simulators, it is possible to solve time-consuming multidimensional simultaneous linear equations on the square order of the ran of the coefficient matrix of the simultaneous linear equations for each search or optimization procedure, compared to conventional calculation methods using the direct method requiring calculation time on the cubic order of the rank of the coefficient matrix in deriving solutions of simultaneous linear equations for each same procedure.

### BRIEF DESCRIPTION OF THE DRAWINGS

The preferred embodiments according to the invention will be explained below referring to the drawings, wherein:

FIG. 1 is a component connection diagram of a science and engineering simulator using a numerical analysis method for simultaneous linear equations according to one embodiment of the invention;

FIG. 2 is a flowchart of a calculation algorithm for a science and engineering simulator using a numerical analysis method for simultaneous linear equations according to one embodiment of the invention;

FIG. 3 is a component connection diagram of a science and engineering simulator using a numerical analysis method for simultaneous linear equations according to another embodiment of the invention;

FIG. 4 is a flowchart of a calculation algorithm for a science and engineering simulator using a numerical analysis method for simultaneous linear equations according to another embodiment of the invention; and

FIG. 5 is a flowchart which follows the flowchart of FIG. 4.

### DETAILED DESCRIPTION OF THE PREFERRED EMBODIMENTS

One of the reasons for using a science and engineering simulator is because, even in the case of one phenomenon to be verified, there are plural physical actual conditions causing it. In the case of one phenomenon to be verified and one physical actual condition, a science and engineering simulator is used only once. In that case, use of the science and engineering simulator is prohibitively high in cost for experimental verification so that it makes no sense to introduce the science and engineering simulator. To apply physical control equations to physical actual conditions, sets of segments obtained after the same actual conditions are made discrete are represented by equation (1):
S1=(s11, s12, . . . s1m1),
S1=(s21, s22, . . . s2m2),
Sn=(sn1, sn2, . . . snmn) (1)
It should be noted that the total number of elements of set Si (i=1, 2, . . . , n) is denoted by mi.

Let the union of these sets be S, then equation (2) holds:
S=S1∪S2∪ . . . ∪Sn (2)

In this case, the elements of S are expressed by equation (3);
S=(s1, s2, . . . sm) (3)

In a very exceptional case, equation (4) follows;
φ=Si∩Sj: i, j=1, 2, . . . n (4)

This is because, in almost all cases of verification of plural physical actual conditions for one phenomenon to be verified by a science and engineering simulator, there is some relationship between those physical actual conditions. This is because, for instance, in the case of using a science and engineering simulator for some optimal design, or for discovering some risk factor, plural physical actual conditions to be verified have some commonality (e.g., structural analogy, comprehensibility). The simultaneous linear equations related to Sk are expressed by equation (5):
Mk·xk=pk (5)

Mk is a square matrix constituted by a known coefficient, xk an unknown vector, and pk a known vector. Optimization or search problems formulated by such a simultaneous linear equation system require causing a particular element of unknown vector xk to approach a value to be sought. Let the entire square matrix representing the entire set S (the union of the sets) to be M, then the unknown vector x and known vector p are defined by equation (6):
M·x=p (6)

In this case, the parameters in optimization or search problems are Si in the set S, and the numerical solution of the optimization or search problems is to cause the value of an element xie tied to a particular element xe of the x in corresponding elements xi of Mi corresponding to the Si, to converge to a target value q predetermined by sequentially selecting the Mi S corresponding to the Si and solving equation (5). Therefore, the simultaneous linear equations of equation (5) with respect to S1, S2, . . . , Sn are solved according to some search guideline. Conventional search guideline, such as a Random method, Polytope method, Polyhegon method, and Genetic Algorithm method, requires calculation of equation (7) for each stage of the search, because Si, i.e., Mi itself is a parameter, and the value of xe is an evaluated value.
M1·x1=c1, M2·x2=c2, . . . Mn·xn=cn (7)

In order to numerically analyze all nontrivial forms of a square-matrix that is components of the simultaneous linear equations (having a trivial solution), as it stands, a repletion or elimination method is used as a basic algorithm. The repletion method is a very efficient calculation method in the case of invariance of coefficient-matrix Mi form for each search stage of optimization or search problems, but it cannot be employed in the case of variance of coefficient matrix Mi form for each search stage, as in the problems of the invention, because no efficient calculation is generally found, except for the special case the coefficient matrix is a symmetrical positive definite matrix. The calculation time of the numerical solution of simultaneous linear equations by the algorithm of the elimination method is proportional to cube of the number of segments obtained by making the object of analysis discrete. Therefore, the order of conventional numerical analysis time of simultaneous linear equations is expressed by equation (8) where τ is basic time. For each search stage, the procedure of consuming the calculation time of cubic order of the rank of the coefficient matrix is repeated plural times, which results in a significant drop in calculation efficiency as the coefficient matrix becomes large.
τ×(m1ˆ3+m2ˆ3+ . . . +mnˆ3) (8)

To overcome the problem of an increase of conventional calculation time, attention is paid to the behavior of not xe or xie, but Mi.

First, the inverse matrix of M is calculated, as in equation (9). This calculation takes cubic time of the rank of M, but is performed only once, and is unnecessary for each search stage of the optimization or search problem.
H=Mˆ(−1) (9)

Let the rank of M be m0, then element xke corresponding to xe is obtained by equation (10) with respect to matrix Mk (m0 kind: k=1 to m0) in which the kth row and kth column are eliminated from M.
Mk·xk=ck, xke∈xk; k=1 to m (10)

The norm between xke and target value Q is calculated. In the case of a sufficiently small norm, Mk itself is physical structure to be obtained. Otherwise, let Mk having xke whose norm is the smallest be M1, then element x1ke corresponding to xe is obtained by equation (11):
M1k·x1k=c1k, x1ke∈x1k; k=1 to m−1 (11)

The norm between x1ke and target value Q is calculated. In the case of a sufficiently small norm, M1k itself is physical structure to be obtained. Otherwise, let M1k having x1ke whose norm is the smallest be M2, then the procedure of sequentially obtaining element xike corresponding to xe by equation (12) is repeated.
Mik·xik=cik, xike∈xik; k=1 to m−i (12)

In this search method, it is possible to process simultaneous linear equations of equation (12) for each stage in square calculation time of rank mi by updated form Hi for each stage of H. Also, each Hi is obtained by eliminating the kth row and kth column of matrix Hia obtained by equation (13). Since it is possible to process each calculation of equation (13) in square calculation time of rank mi, the entire calculation time is on the square order of the rank of the matrix, and is greatly shortened compared to a conventional calculation methods. It should be noted that the vectors in equation (13) are column vectors, and that { }ˆt denotes transposition.
Hia=H(i−1)−δH(i−1)·(ek−hk)·(hk)ˆt,
δ=1/(1+(hk)ˆt·(ek−hk)) (13)

In each procedure from equation (10) to equation (12) above, the deletion of the kth row and kth column from Mi corresponds to neglecting element ci corresponding to the same kth column, the physical meaning of which is considered to be inappropriateness of external setting conditions for a corresponding element of known vector p. In order to verify whether the evaluation of this “inapproriateness” is appropriate or not, verification matrix Li comprising columns contained in Mi of original coefficient matrix M and rows not contained in Mi may be multiplied by xi to create verification vector ui, and compare elements of ui and of the corresponding known vector p. The result of the verification can be evaluated by whether the norm formed by elements of ui and of the corresponding known vector p is smaller than a predetermined tolerance. That the norm is smaller than the tolerance means that the elements of ui and of the corresponding known vector p are the same, which means that corresponding external conditions cannot be deleted as “inappropriateness”, in which case the elements of ui and of the corresponding vector p and a corresponding row and column of M are therefore again added to ci and Mi to create new ci and Mi. Hi corresponding to the new Mi can be obtained by equation (14), using subvector r comprising only elements contained in original Mi of column vectors to be newly added in M, and only one element ρ not contained in Mi:
Hi=[Hi−ΔHi·r·{r}ˆt·Hi, −ΔHi·r; −Δ{r}ˆt·Hi, Δ]
Δ=1/{ρ−{r}ˆt·Hi·r} (14)
It should be noted that (A1, a1; a2, α] Represents a square matrix having a rank one greater than that of A1 comprising square matrix A1, column vector a1, row vector a2 and constant α.

Since it is also possible to process each calculation of equation (14) in square calculation time of rank mi, the entire calculation time is on the square order of the rank of the matrix, and is greatly shortened compared to conventional calculation methods.

### Embodiment 1

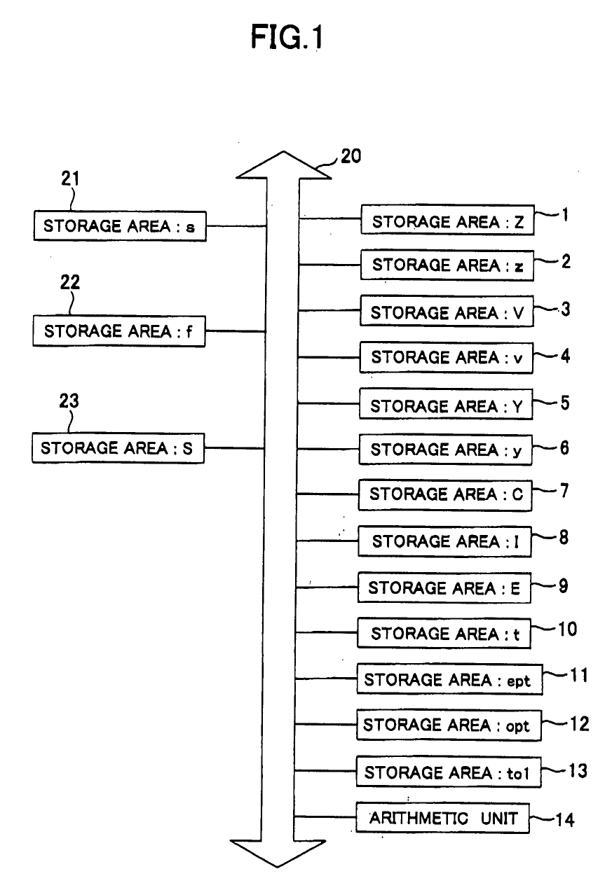

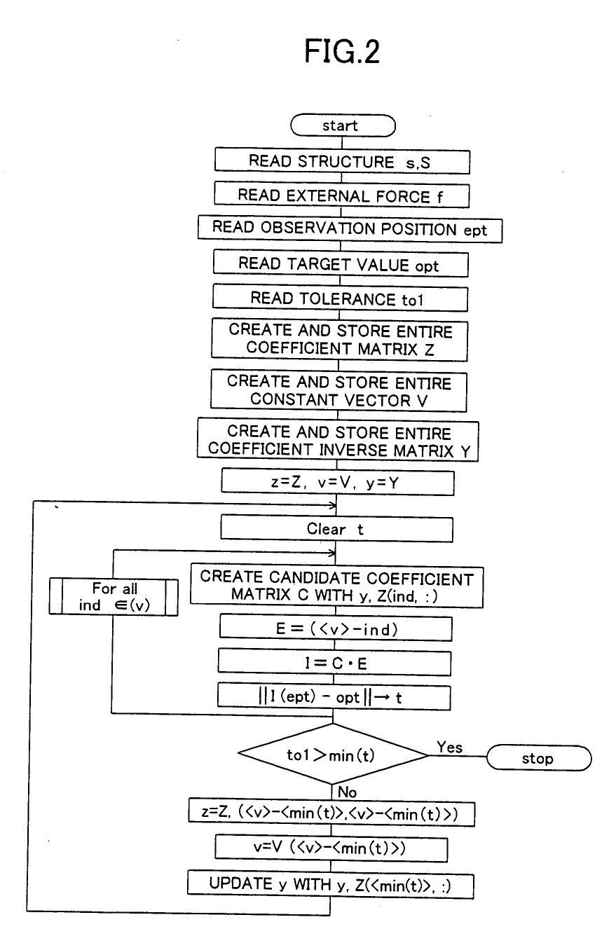

One embodiment of the invention will be explained, referring to FIGS. 1 and 2. FIG. 1 is a diagram showing components and their connection of a science and engineering simulator using a numerical analysis method for simultaneous linear equations according to the invention, and FIG. 2 is a flowchart of a calculation algorithm for a science and engineering simulator using a numerical analysis method for simultaneous linear equations.

As shown in FIG. 1, a science and engineering simulator according to the invention comprises a storage unit 21 (a storage area s) for storing information on sets of segments obtained by making discrete a plurality of concrete objects of analysis of various phenomena to be calculated using the science and engineering simulator; a storage unit 22 (a storage area f) for storing information on boundary conditions including external force conditions corresponding to the respective plurality of objects of analysis set when the plurality of objects of analysis are calculated; a storage unit 23 (a storage area S) for storing the union of the sets of the plurality of segments made discrete stored in the storage unit 21; a storage unit 1 (a storage area Z; a first storage means) for storing a coefficient matrix of simultaneous linear equations corresponding to the sets of the segments stored in the storage unit 23; a storage unit 5 (a storage area Y; a fifth storage means) for storing an inverse matrix of the coefficient matrix stored in the storage unit 1; a storage unit 3 (a storage area V; a second storage means) for storing a constant vector of simultaneous linear equations corresponding to the discrete objects of analysis obtained by information on the boundary conditions including external force conditions corresponding to the discrete objects of analysis stored in the storage unit 22; a storage unit 2 (a storage area z; a third storage means) for storing an updated coefficient matrix comprising elements of the coefficient matrix stored in the storage unit 1; a storage unit 4 (a storage area v, a fourth storage means) for storing an updated constant vector comprising elements of the constant vector stored in the storage unit 3; a storage unit 8 (a storage area I; a first temporary storage area) for storing an unknown vector; a storage unit 7 (a storage area C; a second temporary storage area) for storing a candidate coefficient matrix comprising elements of the updated coefficient matrix stored in the storage unit 2; a storage unit 9 (a storage area E; a third temporary storage area) for storing a degenerate constant vector comprising elements of the updated constant vector stored in the storage unit 4; a storage unit 10 (a storage area t) for stacking the result of calculation for each search stage; a storage unit 11 (a storage area ept) for storing a observation position; a storage unit 12 (a storage area opt) for storing a target value; a storage unit 13 (a storage area tol) for storing a tolerance; an arithmetic unit 14 and a data bus 20, wherein the storage units 1-13 and 21-23 and the arithmetic unit 14 are connected by the data bus 20, and using these storage units 1-13 and 21-23, the arithmetic unit 14 derives data according to needs, performs calculation and writes the result of its calculation.

According to the flowchart of FIG. 2 using the configuration of FIG. 1, the science and engineering simulator using a numerical analysis method for simultaneous linear equations according to the invention first reads, into the storage unit 21, information on sets of segments obtained by making discrete a plurality of concrete objects of analysis of various phenomena to be calculated. It then reads, into the storage unit 22, information on boundary conditions including external force conditions corresponding to the respective plurality of objects of analysis set when the plurality of objects of analysis are calculated. Using information on the sets of the plurality of segments made discrete stored in the storage unit 21, the arithmetic unit 14 calculates information on the union of the sets of the same plurality of segments made discrete, and stores it result into the storage unit 23.

Subsequently, using information on the union of the sets of the segments stored in the storage unit 23, the arithmetic unit 14 calculates a coefficient matrix of simultaneous linear equations corresponding to the union of the sets, and writes its result into the storage unit 1. Subsequently, using the coefficient matrix stored in the storage unit 1, the arithmetic unit 14 calculates an inverse matrix of the same coefficient matrix, and writes its result into the storage unit 5.

Subsequently, using the coefficient matrix stored in the storage unit 1, the arithmetic unit 14 creates a candidate coefficient matrix in which the coefficient matrix is decreased by rank 1 in row and column, and stores into the storage unit 7. The arithmetic unit 14 further creates a degenerate constant vector which is decreased by dimension 1 in elements corresponding to the row and column, and stores into the storage unit 9. The arithmetic unit 14 reads, through the data bus 20, the candidate coefficient matrix stored in the storage unit 7 and the degenerate constant vector stored in the storage unit 9, derives an unknown vector by a direct method, and stores its value into the storage unit 8. The arithmetic unit 14 extracts a value corresponding to an observation point data of the unknown vector stored in the storage unit 8 based on observation point position information stored in the storage unit 11, and stores the data into the storage unit 10.

The arithmetic unit 14 derives a rank of the updated coefficient matrix stored in the storage unit 2, and thereby repeats the above procedure by the number of the rank. After the above procedure is repeated once, the arithmetic unit 14 calculates sequentially a norm between each data stored in the storage unit 10 and a target value stored in the storage unit 12; determines a row and a column to be deleted of the updated coefficient matrix stored in the storage unit 2 corresponding to data stored in the storage unit 10 which provides the smallest norm, and an element to be deleted of the updated constant vector; and updates the updated coefficient matrix stored in the storage unit 2 through the data bus 20, and the updated constant vector stored in the storage unit 4. The above procedure is repeated sequentially using the updated coefficient matrix stored in the storage unit 2 and the updated constant vector stored in the storage unit 4, and the original coefficient matrix and constant vector stored in the storage units 1 and 3.

In the repetition of the procedure, the arithmetic unit 14 constantly checks whether the calculated norm falls below the tolerance stored in the storage unit 13. In the case of the norm falling below the tolerance, the arithmetic unit 14 terminates the procedure. When the procedure is terminated, the updated coefficient matrix stored in the storage unit 2 shows physical structure to be obtained, whose concrete structure is immediately obtained from data stored in the storage unit 21.

In this embodiment, calculation of simultaneous linear equations by the direct method using a candidate coefficient matrix and degenerate constant vector can be performed by an updated inverse matrix stored in the storage unit 6, updateable sequentially by row and column element of a coefficient inverse matrix stored in the storage unit 5 and a coefficient matrix stored in the storage unit 1 for each search stage, with a square calculation amount of the rank of the matrices.

According to this embodiment, in the search or optimization procedure of a physical phenomenon described by simultaneous linear equations, except for the initialization procedure performed once, calculation time during solving all repeated simultaneous linear equations by the direct method can be realized on the order of the square rank of the matrix, which therefore has the effect of speeding up search or optimization of physical phenomena.

### Embodiment 2

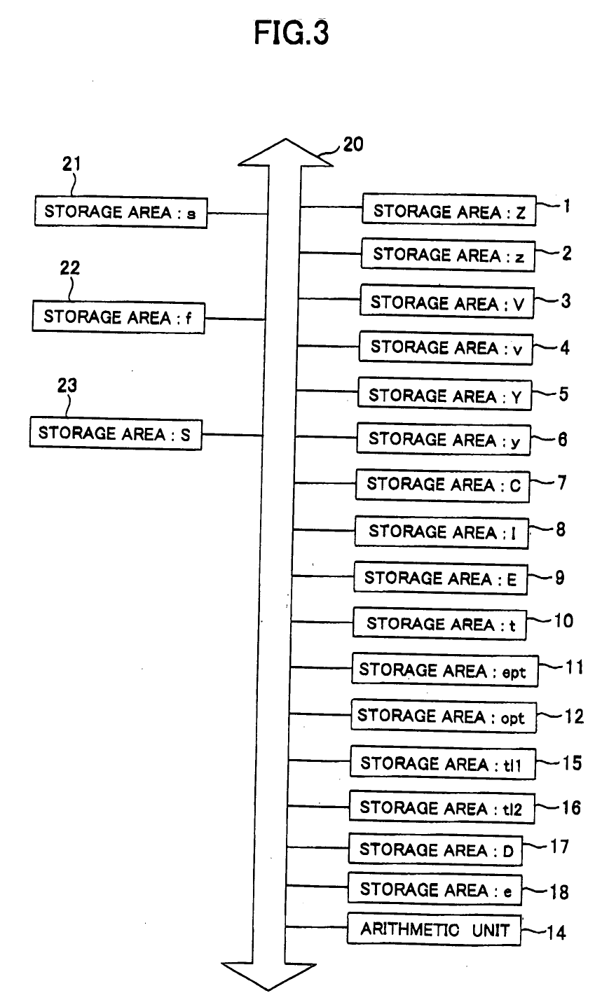

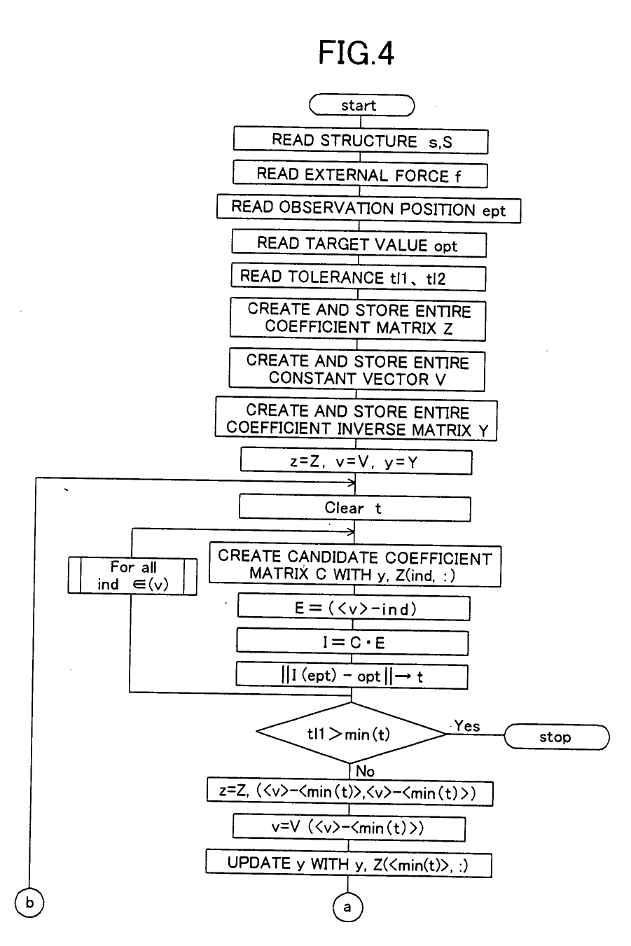

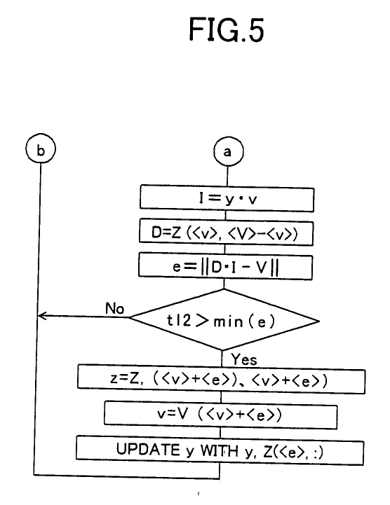

Another embodiment of the invention will be explained, referring to FIGS. 3, 4 and 5. FIG. 3 is a diagram showing components and their connection of a science and engineering simulator using a numerical analysis method for simultaneous linear equations according to the invention, and FIGS. 4 and 5 is flowcharts showing a calculation algorithm for a science and engineering simulator using a numerical analysis method for simultaneous linear equations according to the invention.

FIG. 3 is different from FIG. 1 in that a storage unit 16 (a storage area t12) for storing a coefficient matrix for verification, a storage unit 15 (a storage area t11) for storing a vector for verification and a storage unit 17 (a storage area D; check matrix D) for storing a second tolerance are connected to a data bus 20.

In this embodiment, in addition to the procedures of embodiment 1, after an updated coefficient matrix stored in the storage unit 2 is updated, the arithmetic unit 14 derives a coefficient matrix for verification comprising elements comprising columns contained and rows not contained in the updated coefficient matrix stored in the storage unit 2, of elements of the original coefficient matrix stored in the storage unit 1, and stores into the storage unit 16.

Subsequently, the arithmetic unit 14 performs a multiplication of a coefficient matrix for verification stored in the storage unit 16 and an unknown vector stored in the storage unit 8, and stores its result into the storage unit 17. Further, the arithmetic unit 14 calculates sequentially norms with values stored in the storage unit 17, and corresponding values of a constant vector stored in the storage unit 3, and determines whether they are below the second tolerance stored in the storage unit 17. In the case of the norm falling below the tolerance, rows and columns of the original coefficient matrix stored in the storage unit 1 corresponding to elements of the constant vector stored in the storage unit 3 used for calculation of the norms are newly added to the updated coefficient matrix stored in the storage unit 2, and are stored in the storage unit 2 as a new updated coefficient matrix.

In this embodiment, also, calculation of simultaneous linear equations by the direct method using a candidate coefficient matrix and degenerate constant vector can be performed by an updated inverse matrix stored in the storage unit 6, updateable sequentially by row and column elements of a coefficient inverse matrix stored in the storage unit 5 and a coefficient matrix stored in the storage unit 1 for each search stage, with a square calculation amount of the rank of the matrices, which therefore ensures the effect of reducing calculation time during search or optimization procedure, as in embodiment 1. According to this embodiment, it is possible to inhibit the deletion of given external condition which should originally not be deleted in the search or optimization procedure of embodiment 1, which therefore has the effect of avoiding disadvantage of an unfavorable local optimal solution to ultimate goal in the search or optimization.

According to this embodiment, in the numerical analysis of search or optimization of physical actual conditions of various phenomena using science and engineering simulators, it is possible to solve time-consuming multidimensional simultaneous linear equations on the square order of the rank of the coefficient matrix optimization procedure, which exhibit the effects of high-speed and high-efficiency numerical analysis, compared to conventional calculation methods using the direct method requiring calculation time on the cubic order of the rank of the coefficient matrix in deriving solutions of simultaneous linear equations for each same procedure.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A science and engineering simulator using numerical analysis of simultaneous linear equations, comprising:
a first storage means for storing a coefficient matrix Z of rank-N simultaneous linear equations;
a second storage means for storing a rank-N constant vector V;
a third storage means for storing a rank-n (n<N) updated coefficient matrix z;
a fourth storage means for storing a rank-n updated constant vector v;
a first temporary storage area for storing a rank-n unknown vector I;
a second temporary storage area for storing a rank-n candidate matrix C;
a third temporary storage area for storing a rank-n degenerate vector E; and
an arithmetic unit for executing an algorithm for searching I(ept) determined to converge to opt with predetermined tolerance deviation tol, where the i(ept) is a coefficient of an unknown vector I corresponding to a particular column ept of the coefficient matrix z, and is caused to converge to the particular value opt in an optimization problem wherein:
the candidate matrix C is each element of a set of a combination of all matrices obtained by deleting a plurality of single or same rows and columns of the coefficient matrix Z;
the degenerate vector E is a vector in which elements corresponding to the deleted columns of the coefficient matrix Z are eliminated from the constant vector V;
the updated coefficient matrix is a matrix of elements of the set in which, of solutions of the unknown vector I in simultaneous linear equations constructed by the candidate matrix C and the coefficient matrix Z, the I(ept) is determined to be closest to the opt;
the updated constant vector v is a vector constructed by elements of the constant vector V corresponding to the updated coefficient matrix z; and
same operation is repeated sequentially for z and V.

2. The science and engineering simulator according to claim 1, wherein:
a check matrix D is multiplied by the unknown vector I obtained for each step m of numerical analysis, the check matrix D comprising elements corresponding to columns contained and rows not contained in the updated coefficient matrix z obtained at the end of each step m, the elements being those of the original coefficient matrix Z; and
when a value of same elements in elements of an obtained vector U is determined to be close to a value of corresponding elements of the constant vector V, rows and columns of Z corresponding to positions of the corresponding elements of v are added to the updated coefficient matrix z in step m to create a new updated coefficient matrix z in step m, and elements of V corresponding to positions of the corresponding elements of V are added to the updated constant vector v in step m to create a new updated constant vector v in step m, followed by step m+1 procedure.

3. The science and engineering simulator according to claim 1, further comprising:
a fifth storage means for storing an inverse matrix Y of the coefficient matrix Z; and
a sixth storage means for storing an updated inverse matrix y, wherein:
sequential calculation of y corresponding to z for each step is repeated by rank 1 using y in step m−1 and a row vector of z in step m−1 to be deleted in step m, to derive y in step m; and
calculation of the unknown vector I using the candidate matrix C and the degenerate constant vector E for each step is executed by multiplication of y and a constant vector comprising a subset of the corresponding elements of V.

4. The science and engineering simulator according to claim 2, further comprising:
a fifth storage means for storing an inverse matrix Y of the coefficient matrix Z; and
a sixth storage means for storing an updated inverse matrix y, wherein:
sequential calculation of y corresponding to z for each step is repeated by rank 1 using y in step m−1 and row and column vectors of z in step m−1 to be added in step m, to derive y in step m; and
modification calculation involving an increase in ranks of the updated coefficient matrix 2 and, the updated inverse matrix y is executed according to determination by the check matrix D.

5. The science and engineering simulator according to claim 1, wherein:
the criterion for determining that I(ept) is closest to the target value opt is defined by the smallest norm formed by I(ept) and opt.

6. The science and engineering simulator according to claim 2, wherein:
the criterion for determining that a value of same elements in elements of the obtained vector U is close to a value of corresponding elements of the constant vector V, is defined by the smallest norm formed by the corresponding elements of U and V.

7. The science and engineering simulator according to claim 1, aiming to analyze structural mechanical properties of the object of analysis.

8. The science and engineering simulator according to claim 1, aiming to analyze electrical and electronic circuit properties of the object of analysis.

9. The science and engineering simulator according to claim 1, aiming to analyze electromagnetic properties of the object of analysis.

10. The science and engineering simulator according to claim 1, aiming to analyze fluid-dynamic properties of the object of analysis.
